(19) United States
(12) Patent Application Publication
(10) Pub. No.: US 2006/0235134 A1
(43) Pub. Date: Oct. 19, 2006

(54) Hot-melt adhesive materials

(76) Inventors: Sebastijan Bach, Langweid (DE); Hans-Friedrich Herrmann, Gross-Gerau (DE); Gerd Hohner, Gersthofen (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/533,475

(22) PCT Filed: May 18, 2004
(86) PCT No.: PCT/EP04/05322

§ 371 Date: Apr. 20, 2006

(30) Foreign Application Priority Data
May 26, 2003 (DE) 103 23 617.1

(51) Int. Cl. C08K 5/01

(52) U.S. Cl. 524/487

(57) ABSTRACT

The invention relates to hot-melt adhesive materials containing polyolefin waxes, wherein said polyolefin waxes are produced with the aid of metallocen catalysts and have a ring/ball dripping or softening point between 80 and 165° C. and a maximum melt viscosity of 40000 mPa·s, measured at a temperature of 10° C. above the dripping or softening point.

The invention pertains to hotmelt adhesives comprising polyolefin waxes prepared using metallocene catalysts.

Hotmelts are solvent-free adhesives which are applied in the hot, liquid-melt state to the substrates to be bonded and which develop their adhesive effect after they solidify. Because of their multifarious advantages they are increasingly being used in industries including those of packaging, furniture, textiles, and footwear as an economic and environment-friendly alternative to conventional solvent-based adhesives. Constituents of common hotmelt formulas are polar or nonpolar polymers (generally ethylene-vinyl acetate copolymers), resins, and waxes.

The polar or nonpolar polymers serve as scaffold material; they ensure the cohesion of the adhesive and at the same time contribute to the adhesion to the substrate. The resin addition improves the adhesion and may exert a compatibilizing effect on the various components of the adhesive. Waxes are used for modification, but where appropriate may also serve as scaffold material. They regulate important physical properties of the adhesives, such as hardness, melt viscosity, and softening point, and in their effect on open time, adhesion, cohesion, etc. decisively influence the performance characteristics.

Waxes used to date have included macrocrystalline and microcrystalline paraffin waxes, Fischer-Tropsch waxes, and polyolefin waxes.

Polyolefin waxes can be prepared by thermal degradation of branched high-polymer polyolefin plastics or by direct polymerization of olefins. Suitable polymerization processes include, for example, high-pressure technologies, where the olefins, generally ethylene, are reacted by a free-radical mechanism at high pressures and temperatures to form branched waxes, and also low-pressure or Ziegler processes, in which ethylene and/or higher 1-olefins are polymerized at comparatively low pressures and temperatures using organometallic catalysts.

A more recently disclosed version of the low-pressure process is a procedure in which the organometallic catalysts used are metallocene compounds. These compounds contain titanium, zirconium or hafnium atoms as active species and are generally employed in combination with cocatalysts, examples being organoaluminum or boron compounds, preferably aluminoxane compounds. The polymerization takes places where necessary in the presence of water as molar mass regulator. The feature of metallocene processes is that in comparison to the older Ziegler technology it is possible to obtain waxes having a narrower molar mass distribution, more uniform comonomer insertion, lower melting points, and higher catalyst yields.

Surprisingly it has now been found that polyolefin waxes prepared using metallocene catalysts are suitable with particular advantage as a formula component for hotmelts. In particular it turned out that hotmelts comprising metallocene waxes have outstanding properties in respect of bond strength (adhesion to the substrate) and low-temperature flexibility.

Subject-matter of the specification are, therefore, hotmelt adhesives comprising polyolefin waxes prepared using metallocene catalysts and having a dropping point or ring & ball softening point of between 80 and 165° C. and a melt viscosity, measured at a temperature 10° C. above the dropping or softening point, of not more than 40 000 mPa·s.

The polyolefin waxes preferably have a dropping point or ring & ball softening point of between 90 and 160° C. and a melt viscosity, measured at a temperature 10° C. above the dropping or softening point, of not more than 30 000 mPa·s.

The melt viscosities here were determined in accordance with DIN 53019 using a rotational viscometer, the dropping points in accordance with DIN 51801/2, and the ring & ball softening points in accordance with DIN EN 1427.

The melt viscosity to DIN 53019 is determined as follows:

The liquid under investigation is located in an annular gap between two coaxial cylinders of which one (the rotor) rotates at constant speed while the other (the stator) is stationary. A determination is made of the rotary speed and of the torque required to overcome the frictional resistance of the liquid within the annular gap. From the geometric dimensions of the system and from the torque and speed values determined it is possible to calculate the shear stress prevailing in the liquid, and the shear rate.

By specifying defined geometrical proportions, the aforementioned standard describes a standard flow pattern for measuring the rheology of newtonian and normewtonian liquids in rotational viscometers with coaxial cylinders.

The dropping point characterizes the meltability of solid fats, lubricants, bitumens, etc. The dropping point is the temperature point at which the test material, applied to the mercury ball of a thermometer—or to nipples, fastened thereto, of dropping point measuring instruments (of the Ubbelohde type, for example)—drops off under its own weight.

According to DIN 51801/2 the procedure with an Ubbelohde-type seed point instrument is as follows:

Cemented to the lower part of a thermometer is a cylindrical metal sleeve onto which a second metal sleeve can be screwed. At the side of this second metal sleeve there is a small opening for pressure compensation and, in the lower part, three locking pins at a distance of 7.5 mm from the lower edge of the sleeve. A cylindrical nipple with a downward taper, made from a copper-zinc alloy (brass) with a copper content of between 58% and 63% by weight, fits into the sleeve.

The upper part of the metal sleeve must be cemented to the thermometer such that when the lower part is screwed on tightly the lower edge of the thermometer vessel ends at the same point as the lower edge of the metal sleeve. The locking pins in the metal sleeve allow the nipple to be introduced into the sleeve in such a way that the thermometer vessel at any given point is equidistant from the walls of the nipple. The prepared sample in a pourable state is introduced to excess into the nipple, which stands on the plate.

At a temperature at which push-on application is still just possible the nipple is pushed carefully onto the mount on the thermometer so that the thermometer vessel is not in contact with the nipple wall.

The thermometer with the nipple is fixed in the middle of the test tube by means of a stopper which has a central through-bore and a notch at one side. The distance between the bottom edge of the nipple and the base of the test tube should be 25 mm. The test tube is suspended vertically in the beaker at up to two thirds of its length. The beaker contains ice-water as bath liquid. The dropping point instrument is then heated so that, starting from about 10° C. below the anticipated dropping point, the temperature increases uniformly by 1° C. per minute.

As the temperature rises, the sample gradually softens. An observation is made of the temperature at which the binder running out from the nipple has reached the base of the test tube.

The ring & ball softening point to DIN EN 1427 is determined as follows:

Two layers of bitumen cast in shouldered rings from copper-zinc alloy are heated in a liquid bath with the change in temperature controlled. Each layer carries a steel ball. The softening point is reported as the arithmetic mean of the temperatures at which the two bitumen layers have softened to the point where the balls enclosed by the bitumen have traveled the measurement path of (25.0±0.4) mm.

The softening point is therefore the temperature at which the material under standard test conditions attains a defined consistency.

The polyolefin waxes preferably have a weight-average molar mass M_{w} of between 1000 and 30 000 g/mol and a number-average molar mass Mₙ of between 500 and 20 000 g/mol.

The molar mass weight average M_{w}, the molar mass number average Mₙ and the resulting ratio M_{w}/Mₙ were determined by gel permeation chromatography at 135° C. in 1,2-dichlorobenzene.

The hotmelt adhesives preferably comprise as polyolefin waxes copolymer waxes of propylene and from 0.1 to 30% by weight of ethylene and/or from 0.1 to 50% by weight of at least one branched or unbranched 1-alkene having 4 to 20 carbon atoms, and having a melt viscosity, measured at a temperature 11° C. above the dropping or softening point, of between 100 and 30 000 mPa·s.

In another embodiment the hotmelt adhesives comprise as polyolefin waxes propylene homopolymer waxes having a melt viscosity, measured at a temperature 10° C. above the dropping or softening point, of between 100 and 30 000 mPa·s.

In a further embodiment the hotmelt adhesives comprise as polyolefin waxes ethylene homopolymer waxes.

The hotmelt adhesives may also comprise as polyolefin waxes copolymer waxes of ethylene and from 0.1 to 30% by weight of at least one branched or unbranched 1-alkene having 3 to 20 carbon atoms.

The olefin homopolymer and copolymer waxes used in the hotmelt adhesives may have undergone polar modification.

The hotmelt adhesives may further comprise fillers or auxiliaries such as plasticizers, pigments, and antioxidants.

Suitable polyolefin waxes include homopolymers of ethylene or higher 1-olefins or their copolymers with one another. 1-olefins used are linear or branched olefins having 3 to 18 carbon atoms, preferably 3 to 6 carbon atoms. These olefins may have an aromatic substitution in conjugation with the olefinic double bond. Examples thereof are propene, 1-butene, 1-hexene, 1-octene or 1-octadecene, and styrene. Preference is given to homopolymers of ethylene or propene or their copolymers with one another. The copolymers are composed of from 70 to 99.9%, preferably from 80 to 99% by weight, of one kind of olefin.

Suitable olefin homopolymer and copolymer waxes are those having a weight-average molar mass M_{w} of between 1000 and 30 000 g/mol, preferably between 2000 and 20 000 g/mol, a number-average molar mass Mₙ of between 500 and 20 000 g/mol, preferably between 1000 and 10 000 g/mol, a dropping point or ring & ball softening point of between 90 and 165° C., preferably between 100 and 160° C., and a melt viscosity, measured at a temperature 10° C. above the dropping or softening point, of not more than 40 000 mPa·s, preferably between 100 and 20 000 mPa·s.

The polyolefin waxes used in accordance with the invention are prepared using metallocene compounds of the formula I.

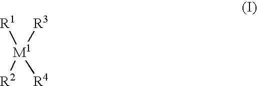

This formula also embraces compounds of the formula Ia 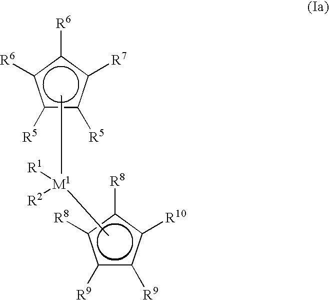
of the formula Ib 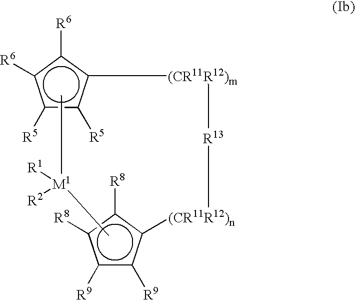
and of the formula Ic

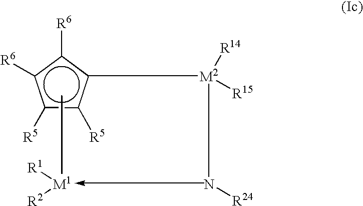

In the formulae I, Ia and Ib, M¹ is a metal from group IVb, Vb or VIb of the periodic table: for example, titanium, zirconium, hafnium, vanadium, niobium, tantalum, chromium, molybdenum or tungsten, preferably titanium, zirconium or hafnium.

R¹ and R² are identical or different and are a hydrogen atom, a C₁-C₁₀, preferably C₁-C₃ alkyl group, particularly methyl, a C₁-C₁₀, preferably C₁-C₃ alkoxy group, a C₆-C₁₀, preferably C₆-C₈ aryl group, a C₆-C₁₀, preferably C₆-C₈ aryloxy group, a C₂-C₁₀, preferably C₂-C₄ alkenyl group, a C₇-C₄₀-, preferably C₇-C₁₀ arylalkyl group, a C₇-C₄₀, preferably C₇-C₁₂ alkylaryl group, a C₈-C₄₀, preferably C₈-C₁₂ arylalkenyl group or a halogen atom, preferably chlorine atom.

R³ and R⁴ are identical or different and are a monocyclic or polycyclic hydrocarbon radical which is able to form a sandwich structure with the central atom M¹. Preferably R³ and R⁴ are cyclopentadienyl, indenyl, tetrahydroindenyl, benzoindenyl or fluorenyl, it being possible for the parent structures to carry additional substituents or to be bridged with one another. Additionally one of the radicals R³ and R⁴ may be a substituted nitrogen atom, in which case R²⁴ has the definition of R¹⁷ and is preferably methyl, tert-butyl or cyclohexyl.

R⁵, R⁶, R⁷, R⁸, R⁹ and R¹⁰ are identical or different and are a hydrogen atom, a halogen atom, preferably a fluorine, chlorine or bromine atom, a C₁-C₁₀, preferably C₁-C₄ alkyl group, a C₆-C₁₀, preferably C₆-C₈ aryl group, a C₁-C₁₀, preferably C₁-C₃ alkoxy group, a radical —NR¹⁶₂—, —SR¹⁶—, —OSiR¹⁶₃—, —SiR¹⁶₃— or —PR¹⁶₂, where R¹⁵ is a C₁-C₁₀-, preferably C₁-C₃ alkyl group or C₆-C₁₀, preferably C₆-C₈ aryl group or else, in the case of radicals containing Si or P, is a halogen atom, preferably chlorine atom, or pairs of adjacent radicals R⁵, R⁶, R⁷, R⁸, R⁹ or R¹⁰ form a ring with the carbon atoms connecting them. Particularly preferred ligands are substituted compounds of the parent structures cyclopentadienyl, indenyl, tetrahydroindenyl, benzoindenyl or fluorenyl. 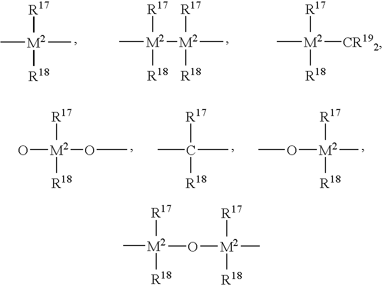
═BR¹⁷, ═AlR¹⁷, —Ge—, —Sn—, —O—, —S—, ═SO, ═SO₂, ═NR¹⁷, ═CO, ═PR¹⁷ or ═P(O)R¹⁷, where R¹⁷, R¹⁸ and R¹⁹ are identical or different and are a hydrogen atom, a halogen atom, preferably a fluorine, chlorine or bromine atom, a C₁-C₃₀, preferably C₁-C₄ alkyl-, particularly methyl group, a C₁-C₁₀ fluoroalkyl-, preferably CF₃ group, a C₆-C₁₀ fluoroaryl, preferably pentafluorophenyl group, a C₆-C₁₀, preferably C₆-C₈ aryl group, a C₁-C₁₀, preferably C₁-C₄ alkoxy, particularly methoxy group, a C₂-C₁₀, preferably C₂-C₄ alkenyl group, a C₇-C₄₀, preferably C₇-C₁₀ aralkyl group, a C₈-C₄₀, preferably C₈-C₁₂ arylalkenyl group or a C₇-C₄₀, preferably C₇-C₁₂ alkylaryl group, or R¹⁷ and R¹⁸ or R¹⁷ and R¹⁹ in each case form a ring together with the atoms connecting them.

M² is silicon, germanium or tin, preferably silicon and germanium. R¹³ is preferably ═CR⁷R⁸, ═SiR⁷R⁸, ═GeR¹⁷R¹⁸, —O—, —S—, ═SO, ═PR¹⁷ or ═P(O)R¹⁷.

R¹¹ and R¹² are identical or different and have the definition specified for R¹⁷. m and n are identical or different and are zero, 1 or 2, preferably zero or 1, with m plus n being zero, 1 or 2, preferably zero or 1.

R¹⁴ and R¹⁵ have the definition of R¹⁷ and R¹⁸.

Examples of suitable metallocenes are:
bis(1,2,3-trimethylcyclopentadienyl)zirconium dichloride,
bis(1,2,4-trimethylcyclopentadienyl)zirconium dichloride,
bis(1,2-dimethylcyclopentadienyl)zirconium dichloride,
bis(1,3-dimethylcyclopentadienyl)zirconium dichloride,
bis(1-methylindenyl)zirconium dichloride,
bis(1-n-butyl-3-methyl-cyclopentadienyl)zirconium dichloride,
bis(2-methyl-4,6-di-isopropyl-indenyl)zirconium dichloride,
bis(2-methylindenyl)zirconium dichloride,
bis(4-methylindenyl)zirconium dichloride,
bis(5-methylindenyl)zirconium dichloride,
bis(alkylcyclopentadienyl)zirconium dichloride,
bis(alkylindenyl)zirconium dichloride,
bis(cyclopentadienyl)zirconium dichloride,
bis(indenyl)zirconium dichloride,
bis(methylcyclopentadienyl)zirconium dichloride,
bis(n-butylcyclopentadienyl)zirconium dichloride,
bis(octadecylcyclopentadienyl)zirconium dichloride,
bis(pentamethylcyclopentadienyl)zirconium dichloride,
bis(trimethylsilylcyclopentadienyl)zirconium dichloride,
biscyclopentadienylzirconium dibenzyl,
biscyclopentadienylzirconium dimethyl,
bistetrahydroindenylzirconium dichloride,
dimethylsilyl-9-fluorenylcyclopentadienylzirconium dichloride,
dimethylsilyl-bis-1-(2,3,5-trimethylcyclopentadienyl)zirconium dichloride,
dimethylsilyl-bis-1-(2,4-dimethyl-cyclopentadienyl)zirconium dichloride,
dimethylsilyl-bis-1-(2-methyl-4,5-benzoindenyl)zirconium dichloride,
dimethylsilyl-bis-1-(2-methyl-4-ethylindenyl)zirconium dichloride,
dimethylsilyl-bis-1-(2-methyl-4-iso-propylindenyl)zirconium dichloride,
dimethylsilyl-bis-1-(2-methyl-4-phenylindenyl)zirconium dichloride,
dimethylsilyl-bis-1-(2-methyl-indenyl)zirconium dichloride,
dimethylsilyl-bis-1-(2-methyltetrahydroindenyl)zirconium dichloride,
dimethylsilyl-bis-1-indenylzirconium dichloride,
dimethylsilyl-bis-1-indenylzirconium dimethyl,
dimethylsilyl-bis-1-tetrahydroindenylzirconium dichloride,
diphenylmethylene-9-fluoroenylcyclopentadienylzirconium dichloride,
diphenylsilyl-bis-1-indenylzirconium dichloride,
ethylene-bis-1-(2-methyl-4,5-benzoindenyl)zirconium dichloride,
ethylene-bis-1-(2-methyl-4-phenylindenyl)zirconium dichloride,
ethylene-bis-1-(2-methyl-tetrahydroindenyl)zirconium dichloride,
ethylene-bis-1-(4,7-dimethyl-indenyl)zirconium dichloride,
ethylene-bis-1-indenylzirconium dichloride,
ethylene-bis-1-tetrahydroindenylzirconium dichloride,
indenyl-cyclopentadienyl-zirconium dichloride
isopropylidene(1-indenyl)(cyclopentadienyl)zirconium dichloride,
isopropylidene(9-fluoroenyl)(cyclopentadienyl)zirconium dichloride,
phenylmethylsilyl-bis-1-(2-methylindenyl)zirconium dichloride, and the alkyl or aryl derivatives of each of these metallocene dichlorides.

The single-centre catalyst systems are activated using suitable cocatalysts. Suitable cocatalysts for metallocenes of the formula I are organoaluminum compounds, especially alumoxanes or else aluminum-free systems such as R²⁰ₓNH₄₋ₓBR²¹₄, R²⁰ₓPH₄₋ₓBR²¹₄, R²⁰₃CBR²¹₄ or BR²¹₃. In these formulae x is a number from 1 to 4, the radicals R²⁰ are identical or different, preferably identical, and are C₁-C₁₀ alkyl or C₆-C₁₈ aryl or two radicals R²⁰ together with the atom connecting them form a ring, and the radicals R²¹ are identical or different, preferably identical, and are C₆-C₁₈ aryl, which may be substituted by alkyl, haloalkyl or fluorine. In particular R²⁰ is ethyl, propyl, butyl or phenyl and R²¹ is phenyl, pentafluorophenyl, 3,5-bistrifluoromethylphenyl, mesityl, xylyl or tolyl.

Additionally in many cases a third component is required in order to maintain protection from polar catalyst poisons. Suitable such components include organoaluminum compounds such as, for example, triethylaluminum, tributylaluminum, and others, and also mixtures.

Depending on the process it is also possible for supported single-center catalysts to be used. Preference is given to catalyst systems in which the residual amounts of support material and cocatalyst do not exceed a concentration of 100 ppm in the product.

For preparing the hotmelt adhesives of the invention it is possible to use metallocene polyolefin waxes without modification or with polar modification. Waxes with a polar modification are obtained in a known way from nonpolar raw materials by oxidation with oxygen-containing gases, air, for example, or by graft reaction with polar monomers, maleic acid or derivatives thereof for example. The polar modification of metallocene polyolefin waxes by oxidation with air is described, for example, in EP 0 890 583 A1, their modification by grafting, for example, in U.S. Pat. No. 5,998,547.

The polyolefin waxes are present in the hotmelt with a weight fraction of between 0.1 and 100%. Further possible constituents include, as scaffold material, nonpolar or polar polymers such as, for example, ethylene-vinyl acetate copolymers, atactic poly-α-olefins (APAO), polyisobutylene, styrene-butadiene-styrene block polymers or styrene-isoprene-styrene block polymers, or else polyamides or polyesters for particularly high-load bonds. Examples of resin components that may be included are rosins and derivatives thereof or hydrocarbon resins. The hotmelt adhesives may further comprise fillers or auxiliaries such as plasticizers, pigments, and antioxidants.

### EXAMPLES

The molar mass weight average M_{w}, the molar mass number average Mₙ, and the resulting ratio M_{w}/Mₙ were determined by gel permeation chromatography at 135° C. in 1,2-dichlorobenzene. The melt viscosities were determined in accordance with DIN 53019 using a rotational viscometer, the dropping points in accordance with DIN 51801/2, and the ring & ball softening points in accordance with DIN EN 1427. The acid numbers—in the case of waxes with polar modification—were determined in accordance with DIN 53402.

The methods according to DIN 53402 are used to determine the acid number of resins, oils, fats, fatty acids, and other industrial organic substances and mixtures. The acid number indicates the amount of potassium hydroxide in mg required under the specified conditions to neutralize 1 g of the sample under investigation.

Procedure:

The sample is weighed to an accuracy of 0.001 g into the titration vessel and is dissolved in 50 ml of solvent mixture. The solution is cooled to room temperature where necessary and, following the addition of 2 or 3 drops of phenolphthalein solution, is titrated rapidly with alcoholic KOH until the red coloration which appears lasts for at least 10 s.

The metallocene polyolefin waxes used in accordance with the invention and listed in Table 1 were prepared by the process specified in EP-A-0 571 882. They all have a weight-average molar mass M_{w} of between 1000 and 30 000 g/mol und a number-average molar mass of Mₙ of between 500 and 20 000 g/mol.

TABLE 1
Polyolefin waxes used

| | | Polymerization | Dropping | Acid | |
|---|---|---|---|---|---|
| | | catalyst or | point | number | Viscosity |
| | Product type | process | ° C. | mg KOH/g | mPa · s |
| Inventive | ethylene homopolymer | metallocene | 125 | — | 60/140° C. |
| example 1 | wax | | | | |
| Inventive | ethylene/propylene | metallocene | 116 | — | 680/140° C. |
| example 2 | copolymer wax | | | | |
| Inventive | propylene-ethylene | metallocene | 120 | — | 460/140° C. |
| example 3 | copolymer wax | | | | |
| Inventive | oxidized ethylene- | metallocene | 105 | 18 | 250/120° C. |
| example 4 | propylene copolymer | | | | |
| | wax* | | | | |
| Inventive | MAn graft product of | — | 121 | 11 | 110/140° C. |
| example 5 | metallocene ethylene | | | | |
| | homopolymer from | | | | |
| | inventive example 1 | | | | |
| Comparative | ethylene homopolymer | Ziegler | 125 | — | 200/140° C. |
| example 1 | wax | | | | |
| Comparative | ethylene/propylene | Ziegler | 118 | — | 600/140° C. |
| example 2 | copolymer wax | | | | |
| Comparative | propylene homopolymer | Ziegler | 158 | — | 710/170° C. |
| example 3 | wax | | | | |
| Comparative | oxidized ethylene- | Ziegler | 108 | 18 | 250/120° C. |
| example 4 | propylene copolymer | | | | |
| | wax** | | | | |
| Comparative | MAn graft product of | — | 122 | 9 | 610/140° C. |
| example 5 | Ziegler-ethylene | | | | |
| | homopolymer wax from | | | | |
| | comparative example 1 | | | | |

*Air-oxidized wax from inventive example 2
**Air-oxidized wax from comparative example 2

Results of Performance Testing

The waxes listed in Table 1 were used to prepare hotmelt adhesives. This was done by melting mixtures of

47.5 g ®Elvax 220 (DuPont) (melt viscosity 230 000 mPa·s/140° C.),

47.3 g ®Resin 835 A (Abieta Chemie GmbH) and

5.0 g of the respective test wax, and also

0.4 g®Hostanox O 10 (Clariant GmbH)

in a glass beaker and stirring the melt at 180° C. for one hour.

These mixtures were used to coat and bond aluminum foils in accordance with DIN 53281. The bond strength was determined in accordance with DIN 53282 (angle peel test).

DIN 53282 specifies the bond area pretreatment of samples of aluminum alloys used for the comparative testing of metal adhesives and metal bonds.

Bond area pretreatment comprises the cleaning, degreasing, chemical treatment, rinsing, and isolation of the bond areas prior to application of the adhesive. The bond areas must be degreased using organic solvents (vapor bath or dip bath) or with inorganic degreasing agents (in a cold bath, hot bath or electrolysis bath, with buffered alkaline solution, for example).

Adhesive bonding should take place as soon as possible after the pretreatment of the bond areas. Adhesive bonding is carried out in facilities which ensure that the prescribed setting conditions (temperature, application pressure, time) are complied with. The temperature must be measured in or on the adhesive layer. The application pressure applied to the bond area must be distributed uniformly, and can be applied mechanically, hydraulically or by vacuum in an autoclave.

The angle peel test to DIN 53282 serves to determine the resistance of metal bonds to peeling forces. The test is used primarily for the comparative assessment of adhesives and adhesive bonds, and also to monitor the bond area pretreatments. For the test, the T-shaped angled bonded sample is loaded by tensile force on its unbonded arms, using a tensile testing machine, until the adhesive layer tears and the two halves of this sample are separate from one another. The force required for this is recorded in a peel diagram, together with a measurement of the change in length between the clamping heads.

To determine the low-temperature flexibility, test specimens measuring 250×10 mm were produced and were bent around a mandrel. The temperature was lowered in 1° steps beginning at 0° C. The measured variable used was the temperature at which the test specimen fractures.

TABLE 2
Properties of the formula mixtures/performance results

| | | Viscosity | | Low- |
|---|---|---|---|---|
| | R&B | at | Bond | temperature |
| | Softening | 180° C. | strength | flexibility |
| Wax used | point ° C. | mPa · s | N/mm | ° C. |
| Inventive example 1 | 91 | 1700 | 0.8 | −5 |
| Comparative example 1 | 82 | 3200 | 0.3 | 0 |
| Inventive example 2 | 87 | 3300 | 1.2 | −10 |
| Comparative example 2 | 87 | 3500 | 0.8 | 0 |
| Inventive example 3 | 73 | 3400 | 1.4 | −15 |
| Comparative example 3 | 101 | 5050 | 1.2 | −5 |
| Inventive example 4 | 84 | 2200 | 1.3 | −10 |
| Comparative example 4 | 85 | 2800 | 1.1 | −10 |
| Inventive example 5 | 76 | 4400 | 1.8 | −20 |
| Comparative example 5 | 78 | 5000 | 1.7 | −10 |

As compared with the comparative examples, the formulae prepared using metallocene wax have generally higher bond strengths and predominantly better low-temperature flexibilities.

1. A hotmelt adhesive comprising between 0.1 and 100% by weight of at least one polyolefin wax prepared using a metallocene catalyst and having a dropping point or ring & ball softening point of between 80 and 165° C. and a melt viscosity, measured at a temperature 10° C. above the dropping or softening point, of not more than 40 000 mPa·s.

2. A hotmelt adhesive as claimed in claim 1 wherein the at least one polyolefin wax has a dropping point or ring & ball softening point of between 90 and 160° C. and a melt viscosity, measured at a temperature 10° C. above the dropping or softening point, of not more than 30 000 mPa·s.

3. A hotmelt adhesive as claimed in claim 1, wherein at least one polyolefin wax has a weight-average molar mass M_{w} between 1000 and 30 000 g/mol and a number-average molar mass Mₙ of between 500 and 20 000 g/mol.

4. A hotmelt adhesive as claimed in claim 1, wherein the at least one polyolefin wax is a copolymer wax of propylene and at least one of from 0.1 to 30% by weight of ethylene and from 0.1 to 50% by weight of at least one branched or unbranched 1-alkene having 4 to 20 carbon atoms, and having a melt viscosity, measured at a temperature 10° C. above the dropping or softening point, of between 100 and 30 000 mPa·s.

5. A hotmelt adhesive as claimed in claim 1, wherein the at least one polyolefin wax is a propylene homopolymer wax having a melt viscosity, measured at a temperature 10° C. above the dropping or softening point, of between 100 and 30 000 mPa·s.

6. A hotmelt adhesive as claimed in claim 1, wherein the at least one polyolefin wax is an ethylene homopolymer wax.

7. A hotmelt adhesive as claimed in claim 1, wherein the at least one polyolefin wax is a copolymer wax of ethylene and from 0.1 to 30% by weight of at least one branched or unbranched 1-alkene having 3 to 20 carbon atoms.

8. A hotmelt adhesive as claimed in claim 1, wherein the at least one polyolefin wax has undergone polar modification.

9. A hotmelt adhesive as claimed in one claim 1, further comprising at least one of a filler or auxiliary.

10. A hotmelt adhesive containing between 0.1 and 100% by weight of polyolefin waxes prepared using metallocene catalysts and having a dropping point or ring & ball softening point of between 80 and 165° C. and a melt viscosity, measured at a temperature 10° C. above the dropping or softening point, of not more than 40 000 mPa·s.

11. A hotmelt adhesive comprising between 0.1 and 100% by weight of a polyolefin wax prepared using a metallocene catalyst and having a dropping point or ring & ball softening point of between 80 and 165° C. and a melt viscosity, measured at a temperature 10° C. above the dropping or softening point, of not more than 40 000 mPa·s.

12. Two or more substrates bonded by a hotmelt adhesive according to claim 1.

13. The two or more substrates as claimed in claim 12, wherein the substrates are selected from the group consisting of wood, paper, plastics, composites, and cellulosic materials.
